(19) United States
(12) Patent Application Publication
(10) Pub. No.: US 2008/0079684 A1
(43) Pub. Date: Apr. 3, 2008

(54) Display device comprising an integrated gate driver

(75) Inventor: Pavel Novoselov, Heerlen (NL)

Correspondence Address: BIRCH STEWART KOLASCH & BIRCH, PO BOX 747, FALLS CHURCH, VA, 22040-0747, US

(73) Assignee: TPO DISPLAYS CORP.

(21) Appl. No.: 11/541,579

(22) Filed: Oct. 3, 2006

(51) Int. Cl. G09G 3/36

(52) U.S. Cl. 345/100

(57) ABSTRACT

An active matrix display device comprising an integrated gate driver and an external driver circuit being arranged for driving the active matrix display in association with the integrated gate driver, the integrated gate driver including a monitoring unit for monitoring changes to the I-V characteristics of TFTs on the integrated gate driver and the external driver circuit includes a processing unit which is arranged for performing measurements on the monitoring unit of the integrated gate driver and for adjusting a gate voltage supplied to a plurality of TFTs on the integrated gate driver.

### BACKGROUND OF THE INVENTION

1. Field of Invention

This invention relates to an active matrix display for an integrated gate driver.

2. Related Art

A thin film transistor liquid crystal device (TFT-LCD) is a popular flat-panel display used in today's consumer electronic and computer systems. Generally, it is known that TFT-LCD use source and gate drivers and a driver circuit that supplies driving voltages to the source and gate drivers for controlling the refreshing of content of the display device.

US2003/0189542 discloses an embodiment of a driver circuit for driving an active matrix display employing a display panel with an integrated gate driver formed on an active substrate of a TFT-LCD. The active substrate has a display area and a peripheral area, the display area comprising a plurality of pixels arranged in a matrix of rows and columns. Each unit pixel includes a thin film transistor), a pixel electrode and a storage capacitor. Each pixel TFT is connected to a data-bus line via its source electrode and a gate-bus line via its gate electrode. A plurality of gate-bus lines connects rows of pixel TFTs to the gate driver. By scanning the gate-bus lines sequentially, and by applying signal voltages to all data-bus lines in a specified sequence corresponding to a video signal, all pixels can be addressed and an image is displayed on the TFT-LCD.

The integrated gate driver also includes TFTs as switching elements. However, when using an integrated gate driver, switching problems in the pixel TFTs may arise that may be noticeable in the pixels, affecting the optical performance of the display device, for example as blackening of the display, disappearance of images etc.

### SUMMARY OF THE INVENTION

The present invention is to better maintain the optical performance of the display device over its lifetime.

This is achieved by means of a display device according to the invention as specified in the independent claim 1. Further advantageous embodiments are defined in dependent claims 2-7.

An active matrix display device comprising an integrated gate driver and an external driver circuit being arranged for driving the active matrix display in association with the integrated gate driver, the integrated gate driver including a monitoring unit for monitoring TFTs on the integrated gate driver, and the external driver circuit comprising a processing unit which is arranged to perform measurements on the monitoring unit of the integrated gate driver and is further arranged to adjust a gate voltage supplied to the integrated gate driver.

Thus, according to a first aspect of the invention, an active matrix display device is provided which has an integrated gate driver. The active matrix display also comprises an external driver circuit that is arranged for driving the active matrix display in association with the integrated gate driver. The gate driver has an integrated monitoring unit, for monitoring the TFTs of the integrated gate driver, for example monitoring the gate voltage, drain current etc. The external driver circuit comprises a processing unit, which is arranged for performing measurements on the monitoring unit of the integrated gate driver.

Preferably, the integrated gate driver has a plurality of gate-bus lines connecting the integrated gate driver to rows of pixel TFTs on the active matrix display. The pixel TFTs are essentially switching elements that are controlled by application of a suitable gate voltage across a gate electrode of the TFTs.

When the integrated gate driver switches rows of pixels ON and OFF for sequentially scanning the gate-bus lines, a relatively high gate voltage is applied to the gate electrode of the TFTs of the integrated gate driver. Repeatedly changing the gate voltage of the integrated gate driver TFTs affects the movement of the mobility carriers of the TFTs and conduction in the TFTs over the lifetime of the device and hence eventually affecting a threshold voltage of the integrated gate driver TFTs. The threshold voltage is the voltage required for switching a TFT from a blocking state to a conducting state. A shift in the threshold voltage may lead to improper switching of rows of pixels, and thus malfunctioning of the display device.

To alleviate these problems, the monitoring unit on the integrated gate driver is associated with a processing unit in external driver circuit. The processing unit performs measurements on the monitoring unit and can determine if there is any shift in the threshold voltage. The processing unit is arranged to determine the shift in the threshold voltage. If a shift is detected in the threshold voltage the external driver circuit can adjust the gate voltage supplied to the TFTs of the integrated gate driver accordingly, so that proper switching of pixel rows is warranted and the optical performance of the display device over the lifetime is maintained.

In a further embodiment the monitoring unit is arranged as an additional TFT on the integrated gate driver having similar characteristics.

Preferably, the monitoring unit is arranged as an additional TFT in the integrated gate driver. The measuring of the I-V characteristics is carried out on the additional TFT. This additional TFT on the integrated gate driver has similar characteristics to the TFTs on the integrated gate drivers and is hence used as the monitoring unit for the TFTs on the integrated gate driver. The monitoring unit of the integrated gate driver suffers from a similar voltage stress as all other TFTs on the integrated gate driver. Preferably, the monitoring unit is arranged as an additional unit on the integrated gate driver. This unit is not connected to a row of pixels, but instead to the processing unit in the external driver circuit for performing measurements.

In a further embodiment, the integrated gate driver comprises a shift register and a plurality of latch cells, a latch cell comprising a pull-up TFT and a pull-down TFT arranged to receive a driving voltage pulse. In yet a further embodiment the monitoring unit is a pull-down TFT or a pull up TFT.

In these preferred embodiments, the integrated gate driver comprises a shift register. The shift register receives the gate voltage from the external driver circuit and is arranged for shifting the gate voltage from one side of the shift register to another side corresponding to the first and last row of pixels. For each row of pixels, a latch cell is provided, which further comprises a pull-up TFT and a pull-down TFT connected to a gate line. When a row is selected, the external driver circuit supplies a gate voltage, referred to as a turn-ON voltage, to the gate electrodes of the pull-up and pull-down TFTs of the latch cell connected to the gate line of that row. The pull-down TFTs are mostly in the ON state and therefore the pull-down TFTs in the latch cells of the shift register generally suffer from the highest voltage stress. Thus, it is an advantage to arrange the monitoring unit as a pull-down TFT.

In a further embodiment, the processing unit of the external driver circuit is arranged to determine an adjusted gate voltage in dependence of the measurements performed.

In a further embodiment, the external driver circuit comprises a plurality of switches for establishing contact with the monitoring unit.

In yet a further embodiment, the external driver circuit comprises a plurality of voltage generating units, and a current measurement unit.

In further preferred embodiments, measurements are made on the monitoring unit of the integrated gate driver by the processing unit in the external driver circuit, during every switch ON process of the integrated gate driver. The processing unit is further arranged for determining an adjusted gate voltage in dependence of the measurements performed on the TFTs on the integrated gate driver.

The processing unit in the external driver circuit is preferably connected to the monitoring unit by means of a switch provided in the external driver circuit. This switch can connect or disconnect the monitoring unit on the integrated gate driver with a voltage generating unit and a current measuring unit in the external driver circuit. When the monitoring unit is disconnected, the monitoring unit doesn't interfere with the functioning of the integrated gate driver.

In a further embodiment, the external driver circuit comprises a plurality of voltage generating unit. A first gate voltage generating unit is connected to the gate electrode of the monitoring unit and is arranged to supply the required voltage to the gate electrode. A second drain-source voltage generating unit is arranged to operate on the drain and source electrodes of the monitoring unit. Further, a current measurement unit is connected to the drain electrode of the monitoring unit and the drain-source voltage generating unit to measure a drain current. The drain current measured from the current measurement unit is then used in the processing unit for calculating an adjusted operating gate voltage by the processing unit in the external driver circuit such that the drain current can be adjusted accordingly during the lifetime of the display.

### BRIEF DESCRIPTION OF THE DRAWINGS

Aspects of the present inventions will become apparent from and will be elucidated with respect to the embodiments described hereinafter with reference to the accompanying drawings. The drawings illustrate the embodiments of the invention and together with the description, serve to explain the principles of the invention.

In the drawings:

FIG. 1 shows a schematic overview of an AMLCD with an integrated gate driver and an external driver circuit,

FIG. 2 shows a schematic representation of the architecture of the integrated gate driver and the external driver circuit,

FIG. 3 shows a schematic overview of the I-V characteristics for a TFT,

FIG. 4 shows a schematic overview the integrated gate driver, and

FIG. 5 shows a schematic overview of sub circuit for processing.

It should be noted that the above-mentioned embodiments illustrate rather than limit the invention and that those skilled in the art will be able to design alternative embodiments without departing from the scope of the appended claims. In the claims, any reference signs should not limit the scope of the claim. The invention can be implemented by means of hardware comprising several distinct elements.

### DETAILED DESCRIPTION OF THE INVENTION

The application will be described below with reference to relevant drawings, wherein the same elements are referred with the same reference numbers.

A TFT is a transistor implemented using thin film technology. Transistors can act as an electrical amplifier or a switch. A negative voltage on a gate electrode of the transistors attracts electrons to its surface and positive charge carriers or holes to the interface between the semiconductor and insulator to form an “accumulation layer”. When a voltage is applied across a source and a drain electrode of the transistor, a current flows between them. In this way a voltage at the gate electrode can control a voltage between the source and drain.

Display devices may comprise TFTs that are switching elements on an integrated gate driver, switching rows of pixels ON and OFF by sequentially scanning a gate bus line.

Generally, a relatively high voltage is applied to the gate electrode in order to turn ON the TFTs. This high voltage causes a shift in the threshold voltage of the TFTs on the gate driver and results in improper switching of the pixels. Therefore, in the present invention a monitoring unit is attached to the integrated gate driver. The monitoring unit is preferably a TFT, which is not attached to the gate bus lines connected to the rows of pixels, but instead, to a processing unit in the external driver circuit. The arrangement is preferably made such that the monitoring unit suffers from a same voltage stress as any of the other TFTs on the integrated gate driver. The processing unit is arranged for detecting and compensating a shift in the threshold voltage of the TFTs on the integrated gate driver by adjusting the threshold voltage accordingly, thus maintaining the optical performance of the TFTs during the lifetime of the display.

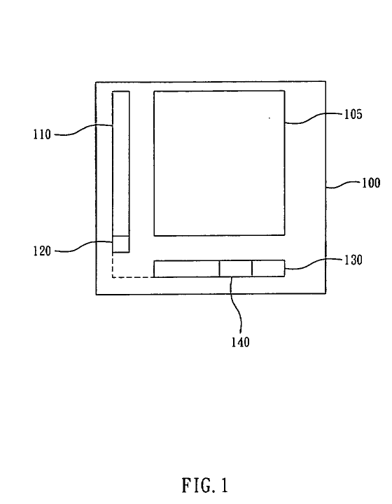

FIG. 1 shows a schematic overview of a device 100 comprising an active matrix liquid crystal device 105 with an integrated gate driver 110 and an external driver circuit 130. The integrated gate driver 10 comprises a monitoring unit 120. The external driver circuit 130 further comprises a processing unit 140. The integrated gate driver 110 has a plurality of gate bus lines that connect the integrated gate driver 110 with rows of pixels TFTs on the active matrix display 105. The integrated gate driver 110 and the external driver circuit 130 together are arranged for driving the active matrix display device 105.

The monitoring unit 120 forms an additional unit on the integrated gate driver 110 and is not connected to rows of pixel TFTs on the active matrix display, but is connected to the external driver unit 130 and in particular to the processing unit 140. The monitoring unit 120 is preferably a TFT. Initially, the I-V characteristics of the monitoring unit 120 are similar to that of the TFTs on the external gate driver 130. Therefore, the monitoring unit 120 suffers from the same voltage stress as the TFTs on the external gate driver 130 and develops similar I-V characteristics over the lifetime of the display device.

The processing unit 140 in the external driver circuit 130 performs measurements on the monitoring unit 120 and is arranged to determine various parameters for example the drain current and a shift in the threshold voltage supplied to the TFTs on the integrated gate driver 110. If a shift in the threshold voltage is detected, the processing unit 140 in the external driver circuit 130 is arranged for compensating this shift by adjusting the gate voltage being supplied to the TFTs on the integrated gate driver (110). Thus, during every switch ON process of the integrate gate driver 110 the external driver circuit 130 can measure the I-V characteristics by performing measurements on the monitoring unit, which is equivalent to performing measurements on the TFTs of the integrate gate driver 110. In addition, the processing unit (140) is also arranged for calculating the optimal ON and OFF gate voltages for the TFTs.

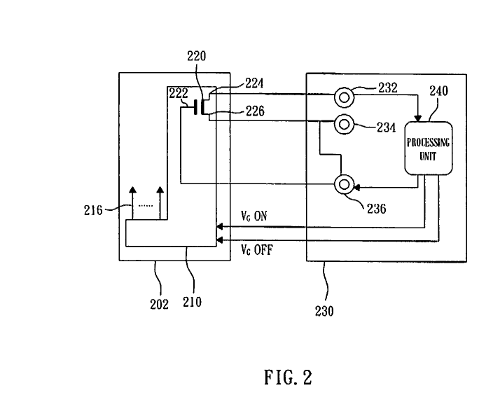

FIG. 2 shows a schematic overview of the architecture of the combined integrated gate driver and monitoring unit 202 and the external driver circuit 230. The integrated gate driver 210 further comprises a monitoring unit 220 as an additional unit. The monitoring unit 220 is preferably a TFT comprising a gate electrode 222, a drain electrode 224 and a source electrode 226.

The external driver circuit 230, in addition to the processing unit 240, also comprises a current measurement unit 232 a drain voltage generator unit 234 and a gate voltage generating unit 236.

The drain electrode 224 of the monitoring unit 220 is connected to a current 5 measurement unit 232 of the external driver circuit 230. The source electrode 226 of the monitoring unit 220 is connected to a drain voltage generator unit 234 and a gate voltage generating unit 236 of the external driver circuit 230. The source electrode 226, the drain electrode 224 and the gate electrode 222 are connected to output bumps of the TFT display and then connected to the external driver circuit 230.

The monitoring unit 220 is also connected to a processing unit 240 in the external driver circuit 230 via the voltage and current measurement unit 232, 234, 236. A detailed description of the processing unit 240 will be provided later in the text. A series of gate bus lines 216 that connect the integrated gate driver 210 to rows of pixel TFTs on the active matrix display. The monitoring unit 220 has the same width and length (W, L) as other TFTs of the integrated gate driver 210.

The processing unit 240 is also connected to the integrated gate driver 210 for supplying and monitoring optimal ON and OFF gate voltages to the gate electrodes of the TFTs on the integrated gate driver 210. A relatively high voltage needs to be applied to the gate electrodes of the TFTs on the integrated gate driver 210 to initiate the movement of the mobility carriers in the TFTs. It should be noted here that application of a relatively high voltage to the gate electrodes of the TFTs creates a voltage stress on the TFTs of the integrated gate driver 210. The stress conditions created by the voltage generating units 234, 236 ensure that the monitoring unit 220 suffers from the same voltage stress as other TFTs on the integrated gate driver 210. Over the lifetime, the constant voltage stress this leads to a shift in the threshold voltage of the TFTs.

The current measurement unit 232 measures the drain current and the processing unit 240 uses the measured drain current to calculate the threshold voltage of the TFTs. If any shift in the threshold voltage of the TFTs is detected, the gate voltage supplied to the integrated gate driver TFTs can be adjusted.

The processing unit 240 is arranged for processing the TFT characteristics of the monitoring unit 220. From the measured characteristics received via the current measurement unit 232 in the external driver circuit 230, the processing unit 240 can determine a shift in the threshold voltage and calculate various other parameters such as the gate voltages, the drain current etc. If any shift in the threshold voltage is determined, the processing unit 240 is arranged to compensate any threshold voltage shift by adjusting the gate voltage supplied to the TFTs on the integrated gate driver 210. The processing unit 240 also determines the ON and OFF gate voltages supplied to the TFTs of the integrated gate driver 210 after extracting the threshold gate voltage from the measured I-V characteristics. The processing unit 240 can then be arranged with the external driver circuit 230 for supplying an optimal ON gate voltage to the TFTs in the integrated gate driver 210. By monitoring the I-V characteristics and adjusting the gate voltage accordingly over the lifetime of the device, proper switching of the pixels can be achieved thus maintaining the optical performance of the display over its lifetime.

Therefore, the main purpose of the monitoring unit 220 in the integrated gate driver 210 is that changes to the drain current and/or the gate voltages under the different operating conditions can be monitored thereon. Effectively, the monitoring unit (220) acts as a sensor for indicating the degree of degradation of the TFTs on the integrated gate driver 210. The TFTs degrade over the lifetime of the device due to the shift in the threshold voltage and eventually leading to the failure of the device. Therefore, constantly monitoring and adjusting the gate voltage allows for maintaining the optical performance of the display over its lifetime.

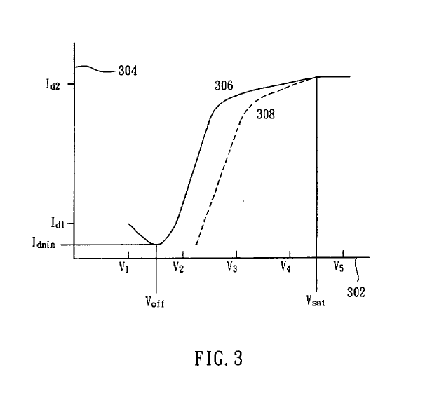

FIG. 3 shows a schematic overview of the I-V characteristics for a TFT. The X-axis 302 represents gate voltage and the Y-axis 304 represents the drain current. The solid line 306 represents the drain current versus the gate voltage for a typical a-Si TFT at 270 degrees Celsius (° C.). At a voltage V1 typically of the order of −10 Volts, the drain current measured is Id1, which is of the order of 1*10-12 amperes. As voltage is increased from V1 to V2, V2 representing a value of the order of 0 volts, the drain current reduces from Id1 to Idmin, Idmin being of the order of 1*10-14 amperes, which is the minima, and the drain current reverses direction at the threshold voltage Vth when the voltage is of the order of −5 volts, and begins moving in the opposite direction. At 0 volts the drain current measured is of the order of 1*10-12 amperes. As voltage increases from V2 to V3 and above till the voltage reaches a value of the order of 25 volts, which represents the saturation voltage Vsat, the drain current steadily increases from Idmin to Id2 that is of the order of 1*10-5 amperes and saturates at the voltage Vsat. Beyond Vsat the drain current is relatively constant and any increase in the gate voltage to the TFTs does not affect the drain current.

The dotted line 308 represents an example of a drain current versus gate voltage characteristics of the same TFT after a certain period of time during which the display was in operation. It can be seen that the threshold voltage (Vth), represented in the figure as Voff, has shifted from −5 volts in the first case, at the beginning of the lifetime of the device, to around 2 volts at a period after the TFTs have been used during a particular stage in the lifetime of the display. This happens due to the constant voltage stress on the gate electrode during the switch ON process that the TFTs undergo during the lifetime of the device. Increasing the voltage steadily increases the drain current until the drain current saturates at Id2 around the same value of the order of 1*10-5 amperes at a voltage of the order of 25 volts. This shift in the threshold voltage needs to be compensated, or else noticeable effects such as degradation in the optical performance of the display because of factors like improper switching of the pixels are noticed. Therefore, the processing unit in the present invention performs measurements on the monitoring unit, which is preferably a separate TFT, and compensates any threshold voltage shift by adjusting the threshold voltage being supplied to the TFTs on the integrated gate driver.

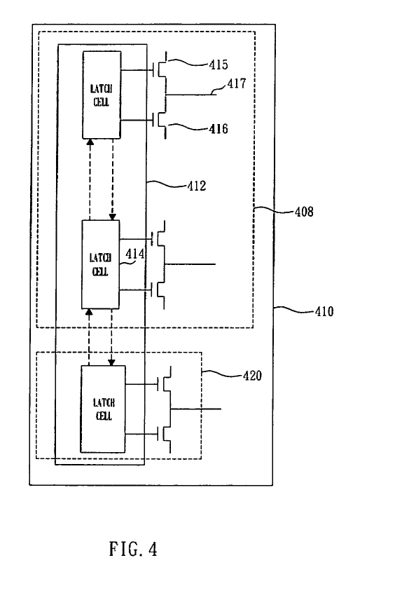

FIG. 4 shows a schematic overview of the integrated gate driver 410. The integrated gate driver 410 comprises two parts, one part 408 that is connected to the active matrix display unit and another part 420, which is the monitoring unit and is not connected to the display unit. Further the integrated gate driver 410 comprises a shift register 412, which further comprises a series of latch cells 414. Each latch cell further comprises a pull up TFT 415, a pull down TFT 416 and a gate bus line 417.

The shift register 412 of the integrated gate driver 410 receives a gate voltage pulse from the external driver circuit and is arranged for shifting the gate voltage from one side of the shift register 412 to another side, which corresponds to the first and last row of pixels, and this part is connected to the display unit.

The shift register 412 comprises a series of latch cells 414 that are connected to each other. Each latch cell has a pull up TFT 415, a pull down TFT 416 and a gate bus line 417 connected to it. The gate voltage is supplied to the TFTs 415, 416 on the shift register 412 via the gate bus line 417.

The shift register 412 also comprises the monitoring unit 420, which is not connected to any of the pixels of the display. The monitoring unit 420 has the same configuration as any other latch cell 414 of the shift register 412, comprising a pull up TFT 415 and pull down TFT 416 and a bus line to supply a gate voltage to the gate electrode of the monitoring unit 420. Preferably the TFTs for monitoring the gate voltage pulse is the pull down TFT 416 on the monitoring unit 420. This is because the pull down TFTs 416 in the integrated gate driver are generally in the ON state and suffers from the highest voltage stress due to the application of a high voltage to the gate electrode. Thus, the pull down TFT (416) of the monitoring unit 420 serves as a sensor to monitor the degradation of all other TFTs on the integrated gate driver.

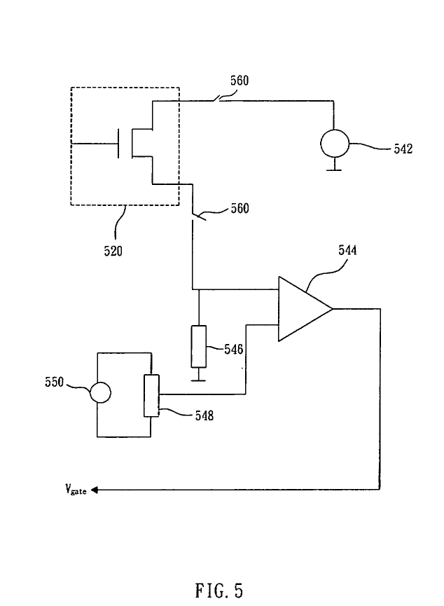

FIG. 5 shows a schematics overview of the processing unit 240. The processing unit 240 comprises a voltage generating unit 542, an operational amplifier 544, a resistor 546, a gate voltage generating unit 550 and a second resistor 548 which is a variable resistor. A pair of switches 560 connects the monitoring unit 520 with the processing unit.

The main feature of the processing unit is to perform measurements on the pull down TFT of the monitoring unit 520 and determine any shift in the threshold voltage, the ON and OFF optimal gate voltages, the drain current etc., of the TFTs on the integrated gate driver.

Measurements are preferably made during every switch ON process. The switch 560 can connect or disconnect the monitoring unit 520 on the integrated gate driver. When the switch 560 is disconnected, the monitoring unit 520 does not interfere with the functioning of the integrated gate driver.

A voltage generating unit 542 in the processing unit 240 creates the necessary voltage levels for measurements to be made. A resistor 546 can convert the current measured to voltages and is also connected to an operational amplifier 544 which adjusts the gate voltage being supplied to the gate electrode of the TFTs on the integrated gate driver to maintain the TFT drain current constant.

The output voltage from the operational amplifier 544 is an optimal gate voltage (Vgate) supplied to the gate electrode of the TFTs. This optimal gate voltage is calculated in the processing unit from the measured I-V characteristics and a variable resistor 548, which is used for making initial adjustments to the device at the beginning of the lifetime of the device.

A gate voltage generator 550 supplies the necessary optimal gate voltage to the operational amplifier 544 to the supplied to the gate electrode of the TFTs. The processing unit is arranged for defining both the optimal (Vgate) ON and OFF gate voltages.

Although the invention has been elucidated with reference to the embodiments described above, it will be evident that other embodiments may be alternatively used to achieve the same object. The scope of the invention is not limited to the embodiments described above, but can also be applied to display devices in general.

It should further be noted that use of the verb “comprises/comprising” and its conjugations in this specifications, including the claims, is understood to specify the presence of stated features, integers, steps, components or groups thereof. It should also be noted that the indefinite article “a” or “an” preceding an element in a claim does not exclude the presence of a plurality of such elements. Moreover, any reference sign does not limit the scope of the claims. Furthermore, the invention resides in each and every novel feature or combination of features.

The invention may be summarized as follows: An active matrix display device comprising an integrated gate driver and an external driver circuit being arranged for driving the active matrix display in association with the integrated gate driver, the integrated gate driver including a monitoring unit for monitoring changes to the I-V characteristics of TFTs on the integrated gate driver and the external driver circuit includes a processing unit which is arranged for performing measurements on the monitoring unit of the integrated gate driver and for adjusting a gate voltage supplied to a plurality of TFTs on the integrated gate driver.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An active matrix display device comprising an integrated gate driver and an external driver circuit being arranged for driving the active matrix display in association with the integrated gate driver, the integrated gate driver including a monitoring unit for monitoring TFTs on the integrated gate driver, and the external driver circuit comprising a processing unit which is arranged to perform measurements on the monitoring unit of the integrated gate driver and is further arranged to adjust a gate voltage supplied to the integrated gate driver.

2. The active matrix display device as claimed in claim 1, wherein the monitoring unit is arranged as an additional TFT on the integrated gate driver having similar characteristics.

3. The active matrix display device as claimed in claim 2, wherein the monitoring unit is a pull-down TFT or a pull-up TFT.

4. The active matrix display device as claimed in claim 1, wherein the integrated gate driver comprises a shift register and a plurality of latch cells, a latch cell comprising a pull-up TFT and a pull-down TFT arranged to receive a driving voltage pulse.

5. The active matrix display device as claimed in claim 4, wherein the monitoring unit is a pull-down TFT or a pull-up TFT.

6. The active matrix display device as claimed in claim 1, wherein the processing unit of the external driver circuit is arranged to determine an adjusted gate voltage in dependence of the measurement performed.

7. The active matrix display device as claimed in claim 1, wherein the external driver circuit comprises a plurality of switches for establishing contact with the monitoring unit.

8. The active matrix display device as claimed in claim 1, wherein the external driver circuit comprises a plurality of voltage generating units, and a current measurement unit.
